(19) United States
(12) Patent Application Publication
(10) Pub. No.: US 2020/0231360 A1
(43) Pub. Date: Jul. 23, 2020

(54) BEVERAGE CONTAINER COUPLER AND RELATED SYSTEMS

(71) Applicant: Proof & Union LLC, Grand Rapids, MI (US)

(72) Inventors: Brian May, Grand Rapids, MI (US); Alden Hoksbergen, Grand Rapids, MI (US); Eric Franco, Grand Rapids, MI (US)

(73) Assignee: Proof & Union LLC, Grand Rapids, MI (US)

(21) Appl. No.: 16/745,886

(22) Filed: Jan. 17, 2020

Related U.S. Application Data
(60) Provisional application No. 62/793,546, filed on Jan. 17, 2019.

(51) Int. Cl. B65D 81/32; A47G 23/02; B65D 25/20; B67B 7/00

(52) U.S. Cl. CPC B65D 81/3211; B67B 7/24; B65D 25/20; A47G 23/0266

(57) ABSTRACT

A beverage container coupler includes a body defining a first cavity open on a first side of the body and configured for removably retaining a first beverage container, a second cavity open on a second side of the body opposite the first side and configured for removably retaining a second beverage container in proximity with the first beverage container, and a fluid path open between the first cavity and the second cavity. The beverage container coupler further includes a puncturing element at least partially positioned within the first cavity.

### CROSS-REFERENCE TO RELATED APPLICATIONS

This application claims priority under 35 U.S.C. § 119(e) and the benefit of U.S. Provisional Application No. 62/793,546 entitled “BEVERAGE CONTAINER COUPLER AND RELATED SYSTEMS,” filed on Jan. 17, 2019, the entire disclosure of which is incorporated herein by reference.

### BACKGROUND

The present device generally relates to a device for coupling together two beverage containers. Specifically, the device provides for various means to physically attach two cans together and to provide fluid connection between the cans such that the contents of both can be simultaneously consumed. Related systems for providing mixed beverages are also disclosed.

### SUMMARY

In at least one aspect of the disclosure, a beverage container coupler includes a body defining a first cavity open on a first side of the body and configured for removably retaining a first beverage container, a second cavity open on a second side of the body opposite the first side and configured for removably retaining a second beverage container in proximity with the first beverage container, and a fluid path open between the first cavity and the second cavity. The beverage container coupler further includes a puncturing element at least partially positioned within the first cavity.

In another aspect of the disclosure, a beverage system includes a first beverage container defining a first interior containing a first liquid, a second beverage container defining a second interior containing a second liquid, and a beverage container coupler. The beverage container coupler is useable such that the first cavity is configured for receiving and removably retaining the first beverage container and the second cavity is configured for receiving and removably retaining the second beverage container in proximity with the first beverage container. The puncturing element opens the fluid path to the first interior when the first beverage container is received in the first cavity.

In another aspect of the disclosure, a method for preparing a beverage includes selecting a first beverage container, defining a first interior containing a selected first liquid, from a plurality of first containers having various different first liquids therein and selecting a second beverage container, defining a second interior containing a selected second liquid, from a plurality of second containers having various different second liquids therein. The method further includes assembling the selected second beverage container at least partially within a second cavity open on a second side of a beverage container coupler and assembling the selected first beverage container at least partially within a first cavity open on a first side of the beverage container coupler opposite the second side. The assembly of the selected first beverage container within the first cavity opens a fluid path from the first interior to the second interior to facilitate mixing of the selected first liquid and the selected second liquid at least one of before or during consumption of the beverage from an opening of the first container outside of the beverage container coupler. In one aspect, the method may include opening the second can along a predetermined opening area prior to assembly.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a front perspective view of a coupler according to an aspect of the disclosure;

FIG. 2 is a top perspective view of the coupler of FIG. 1;

FIG. 3 is a front perspective view of the coupler of FIG. 1 having two beverage containers in the form of cans assembled therewith;

FIG. 4 is an exploded perspective view of the coupler of FIG. 1;

FIG. 5 is a cross section view of the coupler of FIG. 1 with a first sealing element in a first position;

FIG. 6 is a cross-section detail view of a portion of the coupler of FIG. 1 with the first sealing element in a second position;

FIGS. 7-10 are front perspective views showing sequential steps of assembling the two cans with the coupler of FIG. 1;

FIGS. 11 and 12 are cross-section detail views showing sequential steps in engagement of the first container with a puncturing element of the coupler during the steps of assembling the two containers with the coupler; and

FIG. 13 is a schematic depiction of a system including a beverage container coupler and a variety of mixable beverages.

### DETAILED DESCRIPTION OF EMBODIMENTS

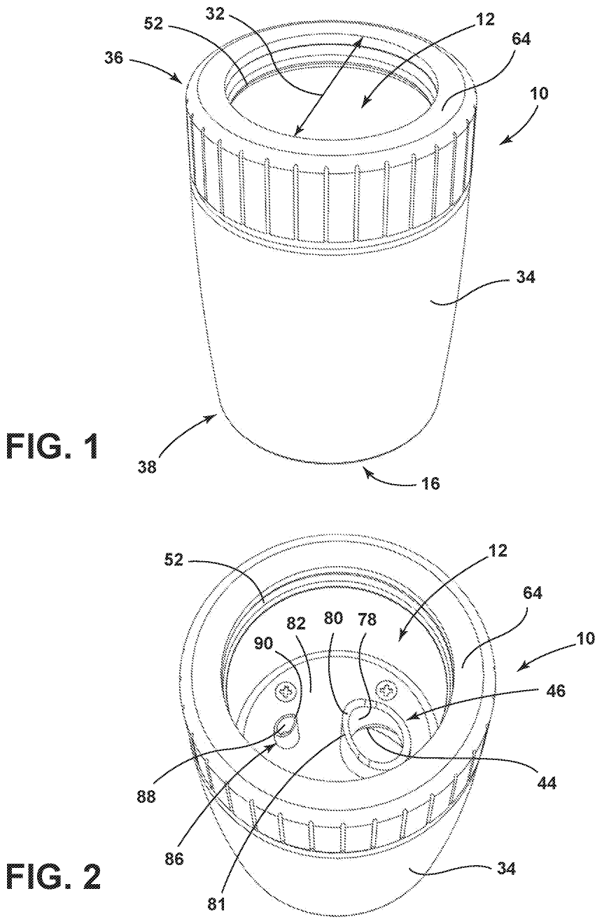

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As generally disclosed with respect to the FIGS. 1-3, reference numeral 10 generally designates a beverage container coupler. The container coupler 10 includes a body 34 defining a first cavity 12 open on a first side 36 of the body 34 and configured for removably retaining a first beverage container 14 and a second cavity 16 open on a second side 38 of the body 34 opposite the first side 36 and configured for removably retaining a second beverage container 18 in proximity with the first beverage container 14. The body 34 further defines a fluid path 44 open between the first cavity 12 and the second cavity 16. The container coupler 10 further includes a puncturing element 46 at least partially positioned within the first cavity 12.

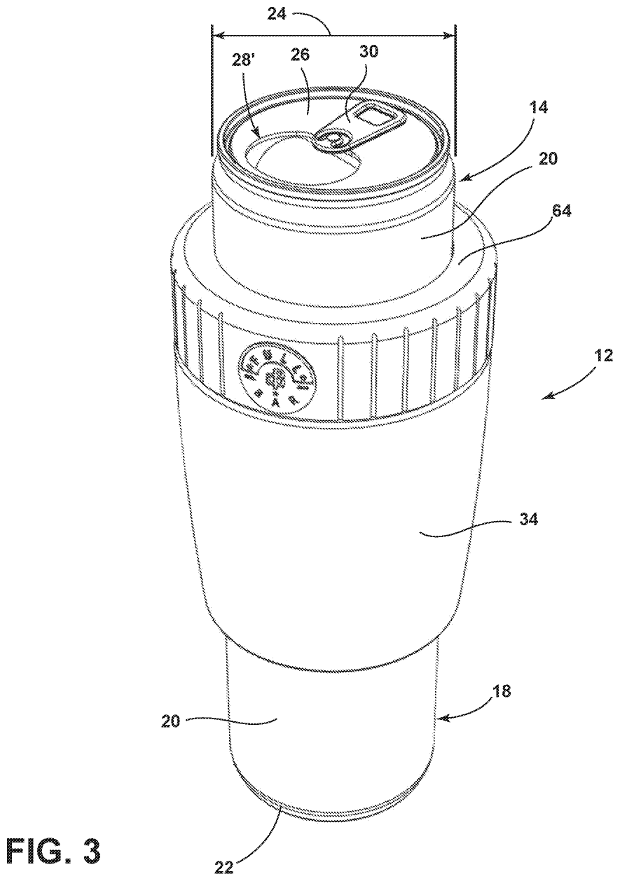

The container coupler 10 described herein and generally illustrated in FIGS. 1 and 2 can be used to join together various arrangements of first and second beverage containers 14 and 18 (an example of which is shown in FIG. 3) with the particular containers and, more significantly, the contents thereof being selected by a user among a number of different containers with respective beverage types. In this manner, the coupling of the beverage containers and the introduction of the fluid path 44, which extends through coupler 10 and, as discussed further below is associated with the respective interiors of the first 14 and second 16 containers, allows for mixing of the contents of the first 14 and second 16 containers. Such mixing can occur both before and during consumption and results in the contents of the first and second containers 16 generally becoming one mixed beverage that is consumed through the first container 14.

As discussed herein, the first and second beverage containers 14 and 18 with which the coupler 10 is intended to operate are various implementations of beverage cans. In general, beverage cans can be manufactured, utilized, and available in a number of configurations, specifics of such that are generally relevant to their use with coupler 10 being discussed herein. In one aspect, such cans are generally made from metal (most commonly, aluminum or various alloys thereof) and include a generally cylindrical side wall 20 with a top cap 24 and a closed bottom 26. Beverage cans of this construction can be made in a variety of particular sizes and top cap 24 configurations, depending on the desired size of the beverage can or other stylistic concerns. In one aspect, the cans comprising the first 14 and second 18 containers can be adapted in size to generally correspond with the type of contents, as discussed further below, and to contain an amount of the particular liquid beverage that accounts for the contents of the first 14 and second 18 containers becoming a single mixed beverage, such that the resulting mixed beverage is of a generally acceptable, or otherwise expected, total quantity (e.g., between 8 and 12 fluid ounces).

By way of example, first container 14 can be adapted for containing a beverage in a relatively smaller quantity (e.g. between 2 and 4 fl. oz. and in one example about 100 ml, or approximately 3.5 fl. oz.) and can have a diameter 24 of about 50 mm and a height of about between about 60 mm and 70 mm (and in one example about 65 mm). Notably, the exact dimensions of the can comprising first container 14 can vary according to factors such as material thickness, tapering of the sidewall 20 toward the top 26 and bottom 22 of the container 14, the shape of the bottom 22 of the container 14, and the structure interface 58 between the top and bottom 22 with the sidewall 20, as well as the desired amount of headspace within container 14, when filled. To provide adequate strength for a container 14 having such dimensions, it may be preferable to fabricate sidewall 20 of a stronger metal than the typical aluminum used for beverage cans. By way of example, such a container 14 can have a sidewall 20 of tin (Sn), various steel compositions, or the like. To allow for sufficient ease of opening container, such as by creating an opening 28′ within the scored area 28 of top cap 26 by use of pull tab 30, the top cap 26 can be fabricated from aluminum and joined with sidewall along the seam forming ridge 58. Similarly, the bottom 22 of the container 14 can be formed by a cap, also of aluminum, that is similarly joined to sidewall 20 at a seam that forms another ridge 58. The cap that comprises the bottom 22 of the container 14 can, in one example, lack the scored area of the top cap 26. The use of aluminum for the bottom 22 of container 14 can, instead, facilitate opening of the fluid path 44 to the interior 48 of first container 14 by penetration of the bottom 22 of the container 14 by puncturing element 46 during assembly of first container 14 into first cavity 12, as discussed further below.

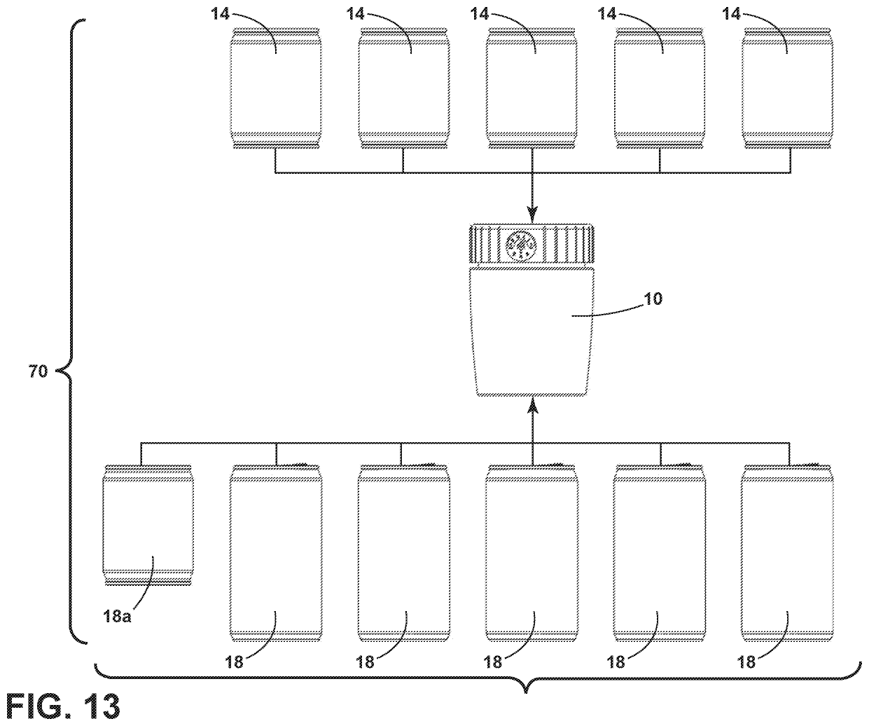

Similarly, the second container 18 can be of a similar diameter 24 as that of first container 14 (which can, in one example, facilitate interoperability of such containers with either cavity 12 or 16, as discussed below), but can be configured with a greater height, such as between about 110 mm and 120 mm (including about 115 mm in one example). In one aspect, coupler 10 can be sized and otherwise configured to operate with containers 14 and 18 having the above-described dimensions, including by way of the shape and configuration of first and second cavities 12 and 16, as discussed further below. Variations of the coupler 10 can be configured, according to the principles discussed herein to operate with containers or differing, or variable sizes, including in diameter. In one example, coupler 10 can be configured to operate with cans that have a generally-accepted “standard” size with a diameter of about 2.6 inches and a height of about 5 inches to contain about 12 fluid ounces of the desired beverage therein (with sufficient allowance for about 0.5 inches of headspace). In one aspect, these types of cans may be referred to as standard 12 oz. cans. As mentioned, many commercially-available cans deviate from these dimensions to, for example, contain a greater or lesser amount of beverage therein to contain the same 12 oz. volume of beverage in a stylistically-distinct can. Consistent with the examples discussed above, some cans may be configured to hold less liquid by reducing the height or diameter of the can below the standard size, while retaining the other standard dimension. In various aspects, discussed herein, coupler 10 can be configured to be interoperable with cans of varying sizes and configurations (including in diameter 24). This can be accomplished, for example, by the configuration of the various sealing elements 52, 66, and 68, as discussed herein, or by making coupler 10 adjustable, such as by allowing for adjustment in the diameter 32 of the cavities 12 and 16, by providing different, interchangeable sealing elements 52, 66, and 68 or by including various spacers or adapters within an overall system 70 (FIG. 13).

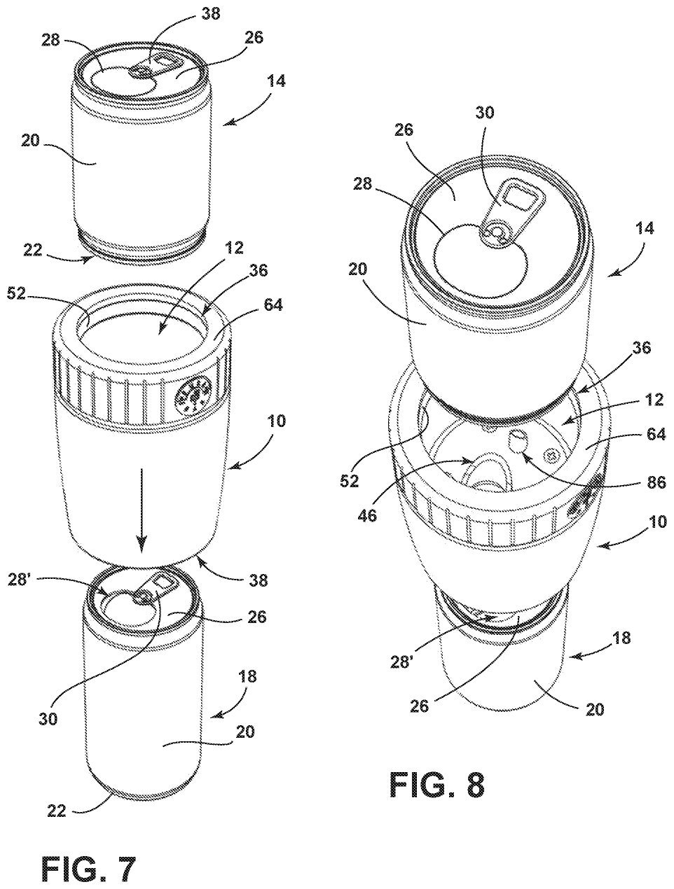

In general, coupler 10, in all of the forms discussed herein, is arranged to retain the so-called “first” beverage container in the corresponding first cavity 12 and the “second” beverage container 18 in the second cavity 16. Notably, the first cavity 12 is shown in a position vertically above the second cavity 16 with respect to the positioning of coupler 10, as it would be held by a user or positioned on a surface when the user is not consuming any of the liquid from either of the beverage containers 14 and 18. In this, respect the designation of the beverage containers 14 and 18 as “first” and “second” is made only to relate to their position within the respective cavities 12 and 16 and does not imply any order or other designation between the containers 14 and 18, unless specifically stating otherwise. In some aspects, the containers 14 and 18 may be of the same configuration. As further shown in FIG. 3 (and FIG. 7), the first beverage container 14 is removably retained in the first cavity 12 with the bottom end 22 thereof facing the top 26 of the second beverage container 18 such that a user may simultaneously consume portions of respective liquids contained in each of the first and second beverage container 14 and 18 with the above-mentioned fluid path 44 open between the first container 14 and the second container 18 to allow the liquid from the second container 18 to flow into and mix with the liquid in the first container 14 prior to or during consumption by the user, as discussed above.

Specific examples of the means for facilitating fluid communication are discussed in greater detail below, but generally include a structure for accessing or creating an opening (in addition to the opening achieved by using pull tab 30 to open the beverage container 14 along the scored opening area 28 along the top 26 of the beverage container 14) at an area of the beverage container 14 that is within the first cavity 12 and a fluid passageway open to and between the accessed or created opening in the first beverage container 14 and an opening in the second container 18. In one aspect, the opening in the second container 18 may be the opening achieved by using the pull tab 30 on the top 26 of the can to open the corresponding scored open area 28. In another aspect, the coupler may be configured to create an additional opening in the second container 18 in an area thereof within the second cavity 16.

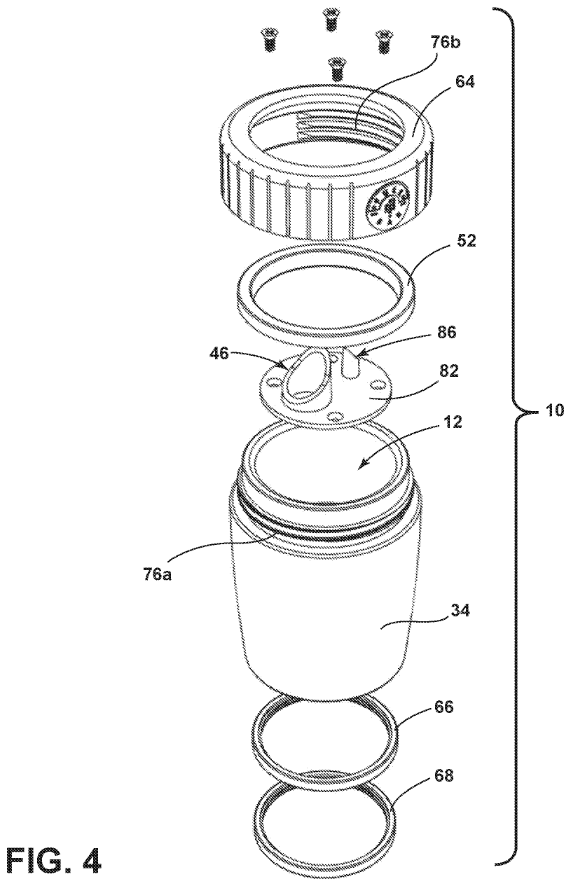

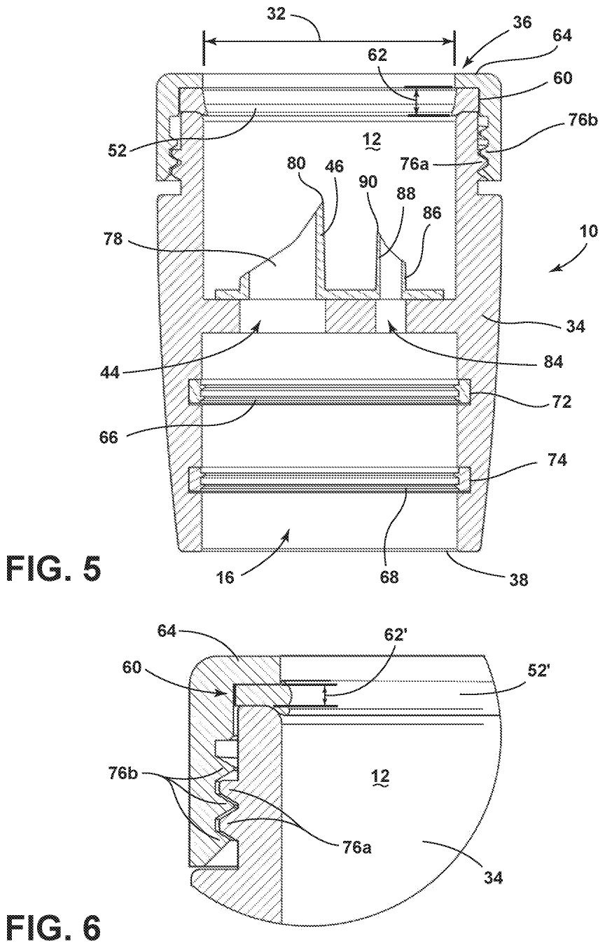

As shown in greater detail in FIGS. 4-6, the first cavity 12 and the second cavity 16 are configured for removably retaining the respective first and second beverage containers 14 and 18 by elastomeric deformation of sealing members 52, 66, and 68 positioned within cavities 12 and 16. In particular, the coupler 10 includes the above-mentioned body 34 that can be of an injection-molded plastic material, such as Acrylonitrile butadiene styrene (“ABS”), Styrene-acrylonitrile resin (“SAN”), Polycarbonate (“PC”) or other similar materials (e.g. in FDA-approved food-safe variations thereof). As shown in FIG. 5, a first seal channel 60 is included within first cavity 12 to receive the sealing element therein. The first seal channel 60 is illustrated as being positioned adjacent the top end 36 of the coupler 10, is generally square-shaped in profile, and extends circumferentially around the entire interior surface of first cavity 12. In this manner, first seal channel 60 can receive the first sealing member 52 in the form of a specifically-adapted or selected O-ring with the sealing member 52 positioned and arranged to contact the sidewall 20 of the first container 14 in a continuous manner around a portion thereof. This configuration allows the first sealing member 52 to both help to retain first container 14 within first cavity 12 (under a reasonable force in at least an axial direction outward from cavity 12) and to prevent any liquid that enters first cavity 12 from the fluid path between opening 44 and the interior 48 of the first container 14 from escaping the first cavity 14.

Similar to the first seal channel 60 of the first cavity 12, the second cavity 16 can include a second seal channel 72 to receive one of the remaining sealing members 66 therein. The second seal channel 72 is generally square-shaped in profile, and extends circumferentially around the entire interior surface of second cavity 16. In this manner, second seal channel 72 can receive the second sealing member 66 therein, which may also be in the form of a specifically-adapted or selected O-ring with the sealing member 66 similarly positioned and arranged to contact the sidewall 20 of the second container 18 in a continuous manner around a portion thereof. This configuration allows the second sealing member 66 to both help to retain second container 18 within second cavity 16 (including under gravity when a user holds an assembly of coupler 10 with first and second containers 14 and 18 by the coupler 10) and to prevent any liquid that enters second cavity 12 from the fluid path between opening 44 and the interior 50 of the second container 18 from escaping the second cavity 18. Both of the sealing elements can be fabricated from various elastomeric materials (including FDA-approved food-safe variations thereof) including silicon, thermoplastic elastomer (TPE), or the like.

In the example shown in FIGS. 5 and 6, the first seal channel 60 can be adjustable to deform the first sealing element 52 from a retracted position (FIG. 5) to an extended position (FIG. 6) with respect to the first cavity 14. More specifically, the top portion of the coupler 36 in the area where the first seal channel 60 is defined can be adjustable in the depicted vertical direction to expand and compress the height 62 of the first seal channel such that the first sealing element 52 can be compressed to cause the desire deformation thereof. In the example shown in the figures, coupler 10 further includes a cap 64 operably coupled with and open on the first side of the body. The portion of the first cavity within which the first sealing element is received is defined between opposing portions of the body and the cap. The cap 64 is operably coupled with the first end 36 of the body 34 such that rotation of the cap 64 with respect to the body 34 adjusts the height 62 of the first seal channel 60 within which the first sealing element 52 is received. By this arrangement, the first sealing element 52 generates a sealing and retaining contact with the first beverage container 14 when deformed into the extended position shown in FIG. 6. The first sealing member 52 and the first seal channel 60, as well as first cavity 12, can be configured to adjust the pressure exerted on first container 14 when inserted into first cavity 14 and when the first sealing member 52 is in the extended position. In particular, the amount of compression of sealing member 52 can be controlled by the reduction in vertical height 64 of the first seal channel 60 that is achieved by rotation of cap 64.

As shown in FIGS. 4-6, the cap 64 can be operably coupled with body 34 by mutually engaging threads 76a and 76b such that the user can twist cap 64 with respect to body 34 to move cap axially downward onto body 34, thus closing the seal channel 60 and compressing the first sealing member 52. The amount of compression achieved and the amount of twisting of cap 64 required can be controlled by the arrangement of the threads 76a and 76b, particularly the pitch thereof. In various implementations, the seal channel 60 can be compressed by between about 2 mm and about 5 mm by, for example, rotation of cap 64 through about one full revolution with respect to body 34. In other implementations, such compression can be achieved through rotation of cap through about one-quarter revolution with respect to body 34. In such an implementation, additional features, such as a detent within one of the threads 76a or 76b can help maintain cap 64 in the turned position corresponding with compression of the first sealing member 52.

When the first sealing member 52 is not in the extended/compressed position, the first container 14 can be freely inserted into or removed from the first cavity 12. In this manner, the positioning of cap 64 in the position shown in FIG. 5 can allow for free or low-effort movement of the first container 14 into the first cavity, including by allowing air to escape from the first cavity 12 from between the first container 14 and the first sealing member 52. This can allow for the bulk of the force applied to the first container 14 to operate against the puncturing element 46, which, as discussed further below, opens the interior 48 of the first container to the opening 44 and the fluid path established thereby. In this manner, the cap 64 and body 14 can be configured such that the diameter 32 of the open end 36 is oversized relative to the diameter of the first container (e.g., by between about 2 mm and 3 mm). Similarly, the first sealing element 52 may be configured to have similar clearance or at least a close contact with little or no pressure with first container in the retracted position. Once the first container 14 is fully assembled within the first cavity 12, the cap 64 can be tightened down onto body 34 to move the first sealing element 52 into the extended position to seal against the sidewall 20 of the first container 14 and to retain first container 14 within first cavity 12. This sealing can be achieved by deformation of the first sealing member 52 to the point that the first sealing member has a natural diameter that is less than that of the first container 14 by, for example, between 0.5 mm and about 1 mm. In this manner, the presence of the first container 14 forces the first sealing member back outward to the diameter of the first container 14, which causes pressure between the first container 14 and the first sealing element 52.

As shown in FIG. 5, the second sealing element 66 is generally fixed within the corresponding second seal channel 72 within the second cavity 16 and extends radially into second cavity 16. In this manner, assembly of the second beverage container 18 with the second cavity 16 establishes a deforming contact with the second sealing element 66 to at least partially retain the second beverage container 18 with the body 34 and to seal against the second beverage container 18. The second sealing element 66 may be fixed because, at least in the present example, the second container 18 can be opened prior to assembly with the coupler 14 (as discussed further below), meaning that no puncturing force is necessary. Further, the second container 18 can be assembled with the coupler 10 prior to the first container 14 such that air can escape from the second cavity through opening 44 and out of the first cavity 12. To provide a desired level of sealing, between second container 18 and the second cavity 14, a third sealing member 68 (FIGS. 4 and 5) can be included within a third seal channel 74 within second cavity 16. The presence of the third sealing member 68 can provide additional fluid sealing to help ensure that no fluid escapes from around the second container 18 and can stabilize the fit between the second container 18 and the second cavity 16 so that the second container 18 does not pitch or roll respect to its longitudinal axis within second cavity 16 (which could disrupt the effectiveness of the first sealing element 66). Both the second 66 and third 68 sealing elements can be of generally known configuration(s) and can be of similar materials to those discussed above with respect to first sealing element 52.

As discussed above, the opening 44 between first 12 and second 16 cavities defines at least a portion of a fluid path between the interior 48 of the first container 14 and the interior 50 of the second container 18, when both are assembled with coupler (FIG. 3). As further shown in FIG. 5 (as well as in FIGS. 4 and 8), the puncturing element 46 can be in the form of a first tube element 78 having a pointed tip portion 80. As shown, the tube element 78 can be cut or sectioned on an angle such that the pointed tip portion 80 is defined by the angled section of the first tube element 78. The first tube element 78 has an open interior aligned with the first opening 44 in the body 34 such that the puncturing element 46 can also define a portion of the fluid path by being in communication with opening 44 and by being placed in communication with the interior 48 of the first container 14, as discussed further below. The pointed tip 80 portion can further define a sharpened edge 81 of the puncturing element 46 to further increase the effectiveness of puncturing element 44 in puncturing the bottom surface 22 of the first container 14. To provide stability and rigidity of the puncturing element 46, the first tube element 78 can be coupled with and can extends from a plate 82 coupled with the body 34, including by screws (or other mechanical fasteners), adhesives, or the like.

As also shown in FIGS. 4, 5, and 8, the fluid path can further include a second opening 84 in the portion of the body 34 between the first and second cavities 12 and 16. To open the second opening 84 to the interior 48 of the first container 14, the coupler 10 can further include a second puncturing element 86 defined as a second tube element 88 having a pointed tip portion 90. The tube element 88 can have an open interior aligned with the second opening 84 with the second tube element 88 being mounted to the same plate 83 to which the first tube element 78 is mounted (both can be affixed by welding or the like). As shown, the first tube element 78 extends from the portion of the body 34 between the first 12 and second 16 cavities at a first distance and defines a first diameter of the open interior thereof with the second tube element 88 extending from the portion of the body 34 at a second distance that is less than the first distance and defines a second diameter of the open interior thereof that is less than the first diameter. Stated differently, the second puncturing element 86 is both shorter and narrower than the first puncturing element 46. In this manner, the first opening 44 in the portion of the body 34 between the first cavity 12 and the second cavity 16, as well as the aligned open area in the first tube element 78 can define a primary portion of the fluid path 92a that can primarily facilitate flow of the respective beverages between and into the first 14 and second 18 containers. The second opening 84 and the open area in the second tube element 88 can define a secondary portion of the fluid path 92b that, at least primarily, allows the pressure between the two interiors 48 and 50 to equalize during fluid movement therebetween.

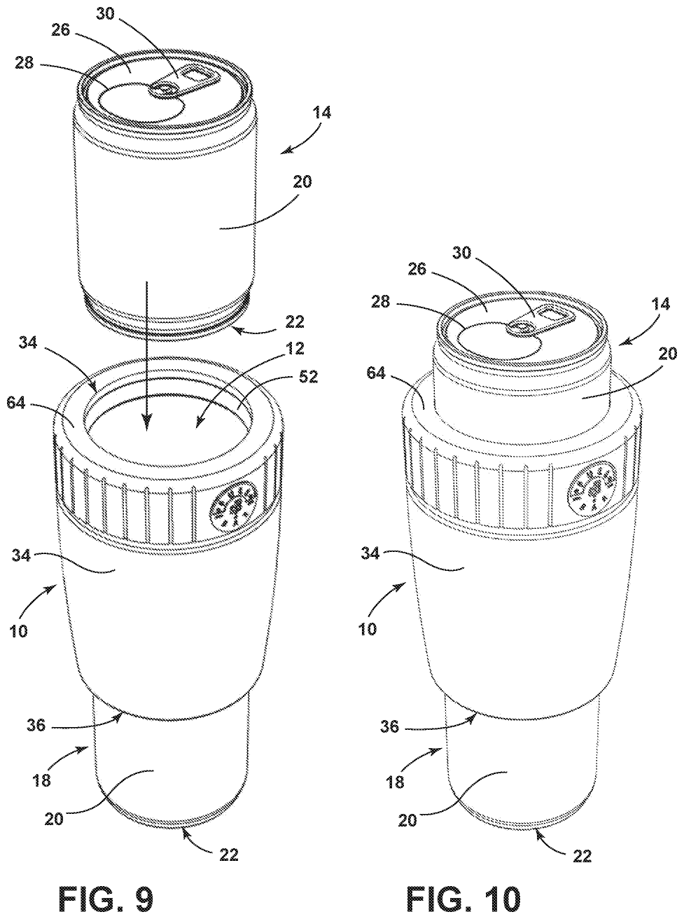

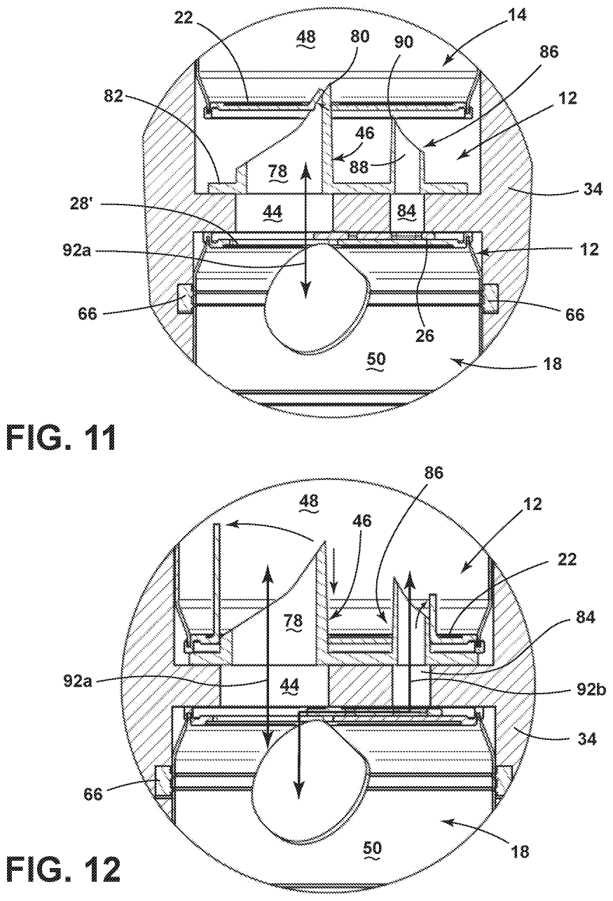

As shown in FIGS. 7-12 the above-described first 14 and second 18 containers can be assembled together using coupler 12 to prepare a mixed beverage that results from a combination of the individual beverages of the first 14 and second 18 containers. As shown in FIG. 7, the selected second beverage container 18, defining the second interior 50 and containing the selected second liquid, is first opened using the provided opening tab 30 to force open the container 18 along the predetermined, scored opening area 28 therein (as shown in FIGS. 7 and 8). The coupler 10 is then arranged such that the second cavity 16 is aligned with the second container 18 and is then pressed down onto the second container 18 so that the second container 18 is positioned within generally occupies all of the second cavity 16 with the top surface 25 of the second container 18 generally contacting the portion of the body 34 separating the first and second cavities 14,16. Because the second beverage container 18 is opened, its interior 50 is in communication with the opening 44, as shown in FIGS. 11 and 12. In other variations of coupler 14, an additional puncturing element can extend into the second cavity 16 and can be configured to force open the top surface 26 of the second container 16, either in the predetermined area 28 or elsewhere.

As shown in FIGS. 10-12, once the selected second beverage container 18 is assembled within the second cavity 16, the selected first beverage container 14 is aligned with and inserted into the first cavity 12 through the open first side 36 of the coupler 10. The assembly of the selected first beverage container 14 within the first cavity 12 opens the fluid path 92a from the first interior 48 to the second interior 50 to facilitate mixing of the selected first liquid and the selected second liquid through the fluid path 92a. As shown, the opening of the fluid path 92a to the interior 48 of the first container is achieved by puncturing of the lower surface 22 of the first beverage container 14 by puncturing element 46. As shown in FIG. 11, such puncturing can occur when the pointed tip portion 80 of the first tube element 78 contacts the lower surface 22 of the first container 18 and can continue as the first container 18 is pressed downward into the first cavity 12 and driven onto and over tube element 78. As shown in FIG. 12, this can include positioning of the first tube element 78 at least partially within the interior 48 of the first container 14 and can cause an adjacent portion of the bottom surface 22 to be pushed away from the tip 80 of the tube element 78 such that it does not block the fluid path 92a. As further shown in FIG. 12 the second puncturing element 86 can similarly puncture the lower surface 22 of the first container 14 to open the secondary flow path 92b to the interior 48 of first container 14.

When both the first container 14 and second container 18 are assembled with the coupler 14, the cap 64 can be tightened onto body 34 to secure the first container 14 within the first cavity 12, and the user can open the first container 14 using the pull tab 30. In one aspect, a portion of the contents of the first container 14 can move under gravity along the primary flow path 92a into the interior of the second container 18 to fill the headspace thereof and to begin the mixing of the contents of the first and second containers 14 and 18. Additionally, the contents of the containers can mix as the user tips the can to consume the contents through the opening 28 in the first container 14. Depending on user preference, the assembly of the first 14 and second 18 containers with coupler 10 can be inverted to cause additional mixing prior to opening of the first container 14.

As shown in FIG. 13, first beverage container 14 can be selected from a plurality of first containers 14 having various different liquids therein, and the second beverage container can be selected from a plurality of second containers 18 also having various different liquids therein. In this manner a system 70, as generally discussed above, can include various first containers 14, each including various liquids in a first category, and various second containers 18, each having various liquids in a second category, with the liquids of the first category being generally intended for mixing with those of the second category in various combinations. In one example, the first category of liquids can include at least one spirit. In this manner, and as discussed above, the first beverage containers 14 are cans configured to retain between about 2 oz. and about 4 oz. of the first liquid (and in one example about 3 oz. or 100 ml). When selected and assembled with the coupler 10, as discussed above, the first beverage container 14 is removably retained in the first cavity 12 with the bottom surface 22 facing a top surface 20 of the second beverage container 18 such that a user may simultaneously consume portions of respective liquids contained in each of the first and second beverage containers 14 and 18, simultaneously. The user selection of the first and second containers 14 and 18 results in a customizable mix of the first and second liquid when the fluid path 92a is open between the first and second containers 14 and 18.

As further shown in FIG. 13, the ability of the coupler 10, as described herein, to join and fluidly couple the first and second containers 14 and 18, as well as to promote or otherwise allow mixing among the contents of the containers 14 and 18 prior to consumption, makes coupler 10 useable in what is described herein as a beverage “system” 70 that allows a user to select two containers based on the particular beverage, etc. in the respective containers and join the containers together as the above-described first and second containers 14 and 18 using coupler 10. In this respect, the coupler 10 can allow a user to mix the two liquids for consumption without separately dispensing the respective contents into an additional container (e.g., a glass). In a further aspect, the coupler 10 can allow the user to create customized beverages based on the selection of the first and second containers 14 and 18 and the assembly of the containers 14 and 18 with the coupler 10.

In a particular implementation of the system, the containers 14 and 18 can include various liquids used as the ingredients or components of a mixed alcoholic drink (or a “cocktail”) with at least one of the containers 14 and 18 including at least one liquid characterized as a “spirit”, such as rum, gin, vodka, tequila, various whiskeys, and the like, a liquor, or other alcoholic beverages that may be mixed as the primary source of alcohol content into a cocktail. In such a system, the other of the containers 14 and 18 may include one or more “mixers”, which may serve to dilute or otherwise supplement the primary alcohol of the spirit. In various examples, mixers may include various sodas (club soda, cola, lemon-lime soda, ginger beer, etc.), tonic water, other “secondary” alcohol sources (such as various types of vermouth, potable and “non-potable” bitters, champagne, beer, etc.), or predetermined mixtures thereof. Depending on the particular configuration of coupler 10, as well as the containers 14 and 18, the first container 14 may include the spirit and the second container 18 may include the mixer, although other arrangements are possible and may be made based on user preference.

In one particular example, aspects of the system may be provided by a common source with the coupler 10, including various types of canned spirits and canned mixers. Such a system 70 may also facilitate the use of a third-party mixer, such as a particular commercially-available cola. For example, a source may make available coupler 10, a canned bourbon, and a preconfigured mixer useable with the canned bourbon to result in an “old fashioned” (in one example, such a mixer can include orange extract or other flavor, cherry juice or other flavor, “aromatic” bitters, and water (or club soda) in a predetermined amount) and may be provided in a variation of the second container 18a that is dimensionally (and volumetrically similar) to that of the first container 14. In this example, selecting the first container 14 as the spirit and the second container 18a as the “old fashioned mixer” (or vice-versa) can allow the user to easily mix such a cocktail. In another example, a user may make a rum-and-cola by selecting a canned rum and the user's preferred canned cola. Other examples, of spirits and mixers are possible. Because the volumes of such ingredients or combined ingredients may vary from the 12 oz. quantity of the above-described “standard” can, the first and second containers 14 and 18 in such a system may vary in size, including in sizes of between 2 oz. and 8 oz. with other sizes being possible, as discussed above.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A beverage container coupler, comprising:
a body defining:
a first cavity open on a first side of the body and configured for removably retaining a first beverage container;
a second cavity open on a second side of the body opposite the first side and configured for removably retaining a second beverage container in proximity with the first beverage container; and
a fluid path open between the first cavity and the second cavity; and
a puncturing element at least partially positioned within the first cavity.

2. The beverage container coupler of claim 1, further including:
a first sealing element received in a portion of the first cavity; and
a second sealing element received in a portion of the second cavity.

3. The beverage container coupler of claim 2, wherein the second sealing element is generally fixed within the portion of the second cavity and extends radially thereinto such that assembly of the second beverage container therewith establishes a deforming contact with the second sealing element to retain the second beverage container with the body and to seal the second cavity against the second beverage container.

4. The beverage container coupler of claim 2, wherein the portion of the first cavity within which the first sealing element is received is adjustable to deform the first sealing element from a retracted position to an extended position with respect to the first cavity, the first sealing element generating a sealing and retaining contact with the first beverage container when deformed into the extended position.

5. The beverage container coupler of claim 4, further including a cap operably coupled with and open on the first side of the body, wherein:
the portion of the first cavity within which the first sealing element is received is defined between opposing portions of the body and the cap; and
the cap is operably coupled with the first side of the body such that rotation of the cap with respect to the body adjusts the portion of the first cavity within which the first sealing element is received.

6. The beverage container coupler of claim 1, wherein:
the fluid path includes a first opening in a portion of the body separating the first and second cavities;
the puncturing element is a first tube element having a pointed tip portion, the first tube element having an open interior aligned with the first opening in the portion of the body.

7. The beverage container coupler of claim 6, wherein the pointed tip portion defines a sharpened edge of the puncturing element.

8. The beverage container coupler of claim 6, wherein the pointed tip portion is defined by an angled section of the first tube element.

9. The beverage container coupler of claim 6, wherein the first tube element is coupled with and extends from a plate coupled with the body.

10. The beverage container coupler of claim 6, wherein the fluid path further includes a second opening in the portion of the body, the beverage container coupler further including:
a second puncturing element defined as a second tube element having a pointed tip portion and an open interior aligned with the second opening in the portion of the body.

11. The beverage container coupler of claim 10, wherein:
the first tube element extends from the portion of the body at a first distance and defines a first diameter of the open interior; and
the second tube element extends from the portion of the body at a second distance that is less than the first distance and defines a second diameter of the open interior that is less than the first diameter.

12. The beverage container coupler of claim 10, wherein:
the first opening in the portion of the body and the open area in the first tube element define a primary portion of the fluid path; and
the second opening in the portion of the body and the open area in the second tube element define a secondary portion of the fluid path.

13. A beverage system, comprising:
a first beverage container defining a first interior containing a first liquid;
a second beverage container defining a second interior containing a second liquid; and
a beverage container coupler, including:
a body defining:
a first cavity open on a first side of the body and configured for receiving and removably retaining the first beverage container;
a second cavity open on a second side of the body opposite the first side and configured for receiving and removably retaining the second beverage container in proximity with the first beverage container; and
a fluid path open between the first cavity and the second cavity; and
a puncturing element at least partially positioned within the first cavity and opening the fluid path to the first interior when the first beverage container is received in the first cavity.

14. The system of claim 13, wherein the first liquid includes at least one spirit.

15. The system of claim 13, wherein the first beverage container is a can configured to retain between about 2 oz. and about 4 oz. of the first liquid.

16. The system of claim 15, wherein the can includes a sidewall of a first material and a bottom surface of a second material, the puncturing element opening the fluid path to the first interior through the bottom surface.

17. The system of claim 16, wherein:
the first material is one of tin or steel; and
the second material is aluminum.

18. The system of claim 13, wherein the first beverage container is removably retained in the first cavity with a bottom surface thereof facing a top surface of the second beverage container such that a user may simultaneously consume portions of respective liquids contained in each of the first and second beverage containers simultaneously.

19. The system of claim 13, wherein:
the first beverage container is one of a plurality of first containers having various different first liquids therein and being selectable by a user for receipt within the first cavity;
the second beverage container is one of a plurality of second containers having various different second liquids therein and being selectable by a user for receipt within the second cavity, the user selection of the first and second containers results in a customizable mix of the first and second liquid when the fluid path is open between the first and second containers.

20. A method for preparing a beverage, comprising:
selecting a first beverage container, defining a first interior containing a selected first liquid, from a plurality of first containers having various different first liquids therein;
selecting a second beverage container, defining a second interior containing a selected second liquid, from a plurality of second containers having various different second liquids therein;
assembling the selected second beverage container at least partially within a second cavity open on a second side of a beverage container coupler; and
assembling the selected first beverage container at least partially within a first cavity open on a first side of the beverage container coupler opposite the second side, the assembly of the selected first beverage container within the first cavity opening a fluid path from the first interior to the second interior to facilitate mixing of the selected first liquid and the selected second liquid at least one of before or during consumption of the beverage from an opening of the first container outside of the beverage container coupler.
